(19) United States
(12) Patent Application Publication
(10) Pub. No.: US 2011/0285194 A1
(43) Pub. Date: Nov. 24, 2011

(54) VEHICLE HEADREST ASSEMBLY

(76) Inventor: Itamar Marom, Bet Dagan (IL)

(21) Appl. No.: 12/933,686

(22) PCT Filed: Apr. 5, 2009
(86) PCT No.: PCT/IL2009/000353

§ 371 Date: Sep. 21, 2010

(30) Foreign Application Priority Data
Mar. 31, 2008 (IL) 190534

(51) Int. Cl. B60N 2/48

(52) U.S. Cl. 297/404

(57) ABSTRACT

A headrest assembly in combination with a vehicle seat (5), the headrest assembly comprising a head/neck support cushion (10) and adapted so that the cushion (10) can be positioned in a location wherein no portion of the headrest assembly blocks the outside view of a driver. According to some embodiments the cushion (10) is manually positionable outside the driver's view, whereas in other embodiments the cushion (10) is automatically positionable.

### TECHNICAL FIELD

The present invention relates to an automotive accessory, in particular a seat headrest assembly.

### BACKGROUND

Vehicle headrests are safety accessories required by law and are intended to protect the head and neck in the event of a sudden change in momentum or an impact, such as caused by a traffic accident or collision.

Although an important safety accessory, headrests also tend to partially block a driver's side and rear view.

Various solutions to this issue have been proposed, including augmenting the driver's field of the vision using mirrors; and designs allowing headrests to be lowered and/or stowed away.

Exemplary headrest assemblies relating to this issue are disclosed in U.S. Pat. Nos. 7,044,555 (to Saberan); and 5,288,129 (to Nemoto).

### SUMMARY OF THE INVENTION

The headrest assembly of the present invention relates to a headrest that is completely removable from a driver's operational view; meaning, the headrest does not block the driver's view in any way or direction. The headrest is applicable to all types of vehicles including vans where the rear wind shield is close to the backseat and therefore does not enable rearward folding of the headrest.

The term “headrest” may be used herein interchangeably with the term “headrest assembly”.

According to some embodiments, the headrest is completely concealed inside the seats of the vehicle; whereas according to other embodiments, the headrest is positioned below the top of the vehicle seat adjacent to the back support portion of the seat. It is a particular feature of some embodiments that the present headrest is automatically controlled and adjustable according to the height of the passengers.

In some embodiments, the headrest is raised and lowered automatically without need for adjustment by the driver or passenger; and in some embodiments, the presence or absence of a driver or passenger is automatically sensed.

Accordingly, the present invention provides a headrest assembly in combination with a vehicle seat, the headrest assembly comprising: a headrest cushion; a mechanism for placing the headrest cushion from an operable position to a position such that the cushion does not block the outside view of a driver, said mechanism being selected from the group consisting of (a) at least one first pipe connected to the vehicle seat; at least one second pipe connected to the cushion and fitable within the at least one first pipe; and a stretchable and flexible member disposed within each of the at least one first pipe and at least one second pipe, each stretchable and flexible member being attached to the second pipe(s) or the cushion, whereby the cushion can be raised and laid on part of the vehicle seat below the top of the vehicle seat; (b) at least one upper bars connected to the cushion; at least one lower bar that extends into at least one pipe in the back support; a pivot arrangement pivotably joining the upper bar(s) and lower bar(s), the seat having a cutout adapted so that the cushion can fit therein and the depth of the cutout is deep enough so that the pivot arrangement does not extend above the top of the seat when the cushion is pivoted forward; (c) at least one rod connected to the cushion; and a cushion/rod-raising and lowering motor operably connected to the at least one rod for raising and lowering the cushion, the seat having a cutout adapted so that the cushion fits therein; and (d) a compartment disposed within the seat and having an openable top pivotably connected to the compartment; an inflatable and deflatable member fitable within the compartment when the member is deflated; an inflating and deflating device operably connected to the inflatable and deflatable member, whereby the inflating and deflating device is adapted to inflate the member thereby opening the top of the compartment and the member acts as a headrest support cushion, and the inflating and deflating device is adapted to deflate the member so that the member retracts back into the compartment.

According to some embodiments, the stretchable and flexible member is a spring. In some embodiments, the spring is a dual diameter spring. In some embodiments, the dual diameter spring has a portion with a first diameter approaching the inner diameter of the first pair of pipes; and a portion with a second diameter approaching the inner diameter of the at least one second pipe. In some embodiments, the spring is compressed when the at least one second pipe is positioned within the at least one first pipe and the assembly further comprises a solenoid adapted so that the solenoid can release the at least one second pipe from within the at least one first pipe whereby the spring pushes the at least one second pipe out of the at least one first pipe and the cushion hangs down adjacent to the seat below the top of the seat.

According to some embodiments, the headrest assembly further comprises a cushion retracting mechanism for retracting the cushion back into an operable position. In some embodiments, the cushion retracting mechanism comprises a cable generally disposed along or within the stretchable and flexible member and operably attached to the cushion and operably attached to a cushion retracting motor for retracting the cushion back into an operable position.

According to some embodiments, the at least one rod is threaded; and the cushion/rod-raising and lowering motor is adapted to rotate at least one gear corresponding to the threads of the at least one rod.

According to some embodiments, the compartment's openable top is adapted to open to a position wherein it supports inflatable and deflatable member. In some embodiments, the inflatable and deflatable member has at least one strap-like member to support the member when it is inflated.

According to some embodiments, the headrest assembly further comprises a sensor for facilitating automatic height adjustment of the cushion and/or for determining if a passenger is seated in the seat.

### BRIEF DESCRIPTION OF THE DRAWINGS

The invention may be more clearly understood upon reading of the following detailed description of non-limiting exemplary embodiments thereof, with reference to the following drawings, in which:

FIGS. 1A-1C relate to a first embodiment of a headrest in accordance with the present invention, wherein FIGS. 1A and 1B are perspective views of the headrest associated with a vehicle seat; and FIG. 1C is a partially sectioned side of an extension mechanism for the headrest;

FIGS. 2A-2C relate to another embodiment of the headrest in accordance with the present invention, wherein FIG. 2A is a perspective view of the headrest associated with a vehicle seat; and FIGS. 2B and 2C are a sectional view and side view, respectively of a mechanism for removing the headrest from the driver's view;

FIGS. 3A and 3B are a perspective view of another embodiment and an enlarged sectional view of a portion of FIG. 3A, respectively;

FIGS. 4A-4C relate to another embodiment of the headrest in accordance with the present invention, wherein FIGS. 4A and 4B are perspective views of the headrest associated with a vehicle seat; and FIG. 4C is an enlarged side view of a mechanism for raising and lowering the headrest;

FIGS. 5A and 5B are perspective views of another embodiment of the headrest in accordance with the present invention, comprising an inflatable headrest cushion; and

FIGS. 6A and 6B are a side and a perspective view, respectively, of a modification of the embodiment of FIGS. 4A-4C.

The figures are intended to aid in understanding the invention and components illustrated therein may not necessarily be drawn to scale.

### DESCRIPTION OF EMBODIMENTS OF THE INVENTION

In many instances, the same reference numbers may be used for similar components, despite modifications thereto, in the various embodiments described below. For the sake of brevity, description details of certain components which are known in the art are omitted.

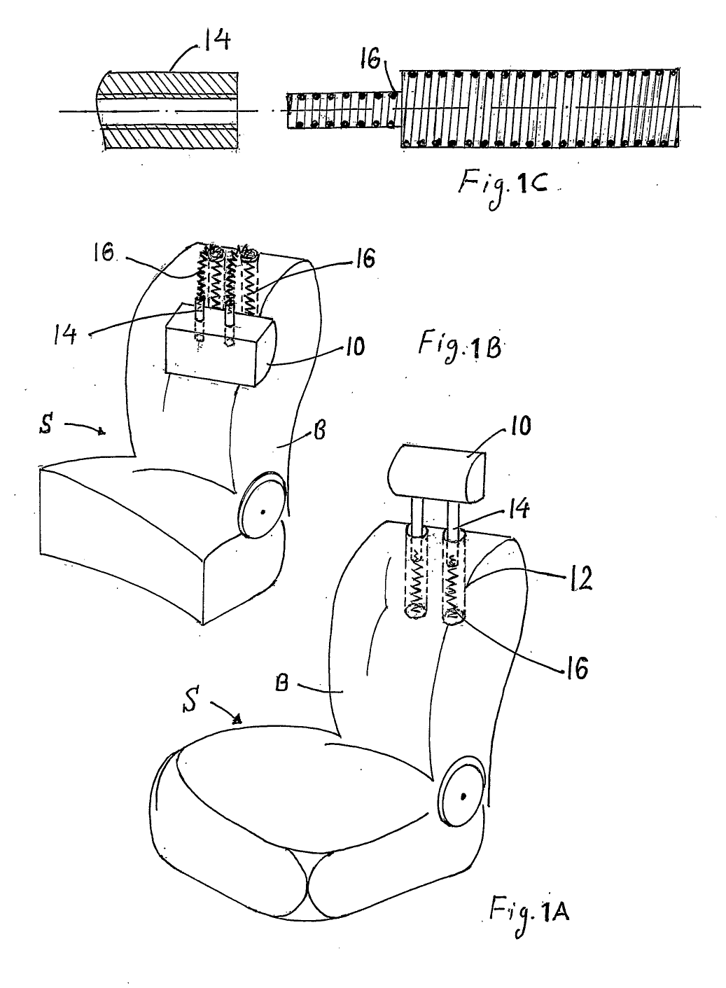

Referring first to FIGS. 1A-1C, there is shown a first embodiment of a headrest of the present invention typically intended to be associated with a vehicle seat S. The headrest comprises a head and/or neck engagement member such as a support cushion 10; and a mechanism for positioning support cushion 10 in a location that does not block a driver's view outside the vehicle, including a first pair of pipes 12 disposed in a back support B of the seat S; a second pair of pipes 14 extending downward from the cushion 10 and into the first pair of pipes 12. Within pipes 12 and 14 is a pair of stretchable and flexible members such as dual diameter springs 16.

According to a preferable embodiment, springs 16 have a first diameter typically approaching the inner diameter of the first pair of pipes 12 and a second diameter, smaller than the first diameter, which typically approaches the inner diameter of the second pair of pipes 14. The top ends of the springs 16 are connected to the second pair of pipes 14 by any suitable manner, for example, threading into a female spiral portion in pipes 14 corresponding to the springs 16, welding, using an adhesive, and so on. The bottom ends of the springs 16 are typically connected to the first pair of pipes 12 as well; however the springs 16 need not be connected to pipes 12 thereby allowing complete removal of the cushion 10 and springs 16. The height of the headrest can be adjusted according to any standard manner.

To remove the headrest from blocking the sight of the driver, cushion 10 is pulled upward until pipes 14 are pulled out from within pipes 12 and then cushion 10 is laid down along back support B below the top of the seat S.

Lifting cushion 10 in this manner, and resting it down along back support B, results in the stretching of springs 16 thereby ensuring that cushion 10 is resting low enough down to not block the driver's vision, whether the seat S is a rear passenger seat or the passenger seat next to the driver. Springs 16 also act as a guide for replacing the headrest to the original position, whereby the headrest is in a proper position for a passenger in the seat S. In this embodiment, the headrest cushion 10 is manually replaced, i.e. pipes 14 are manually replaced within pipes 12 and lowered to a desired headrest height.

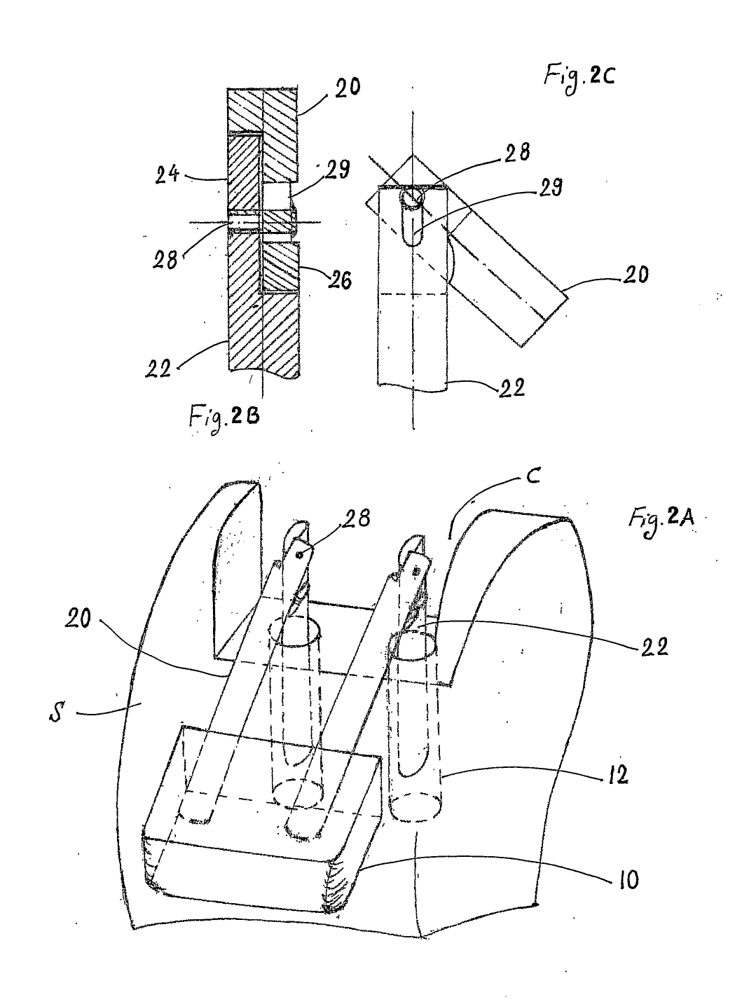

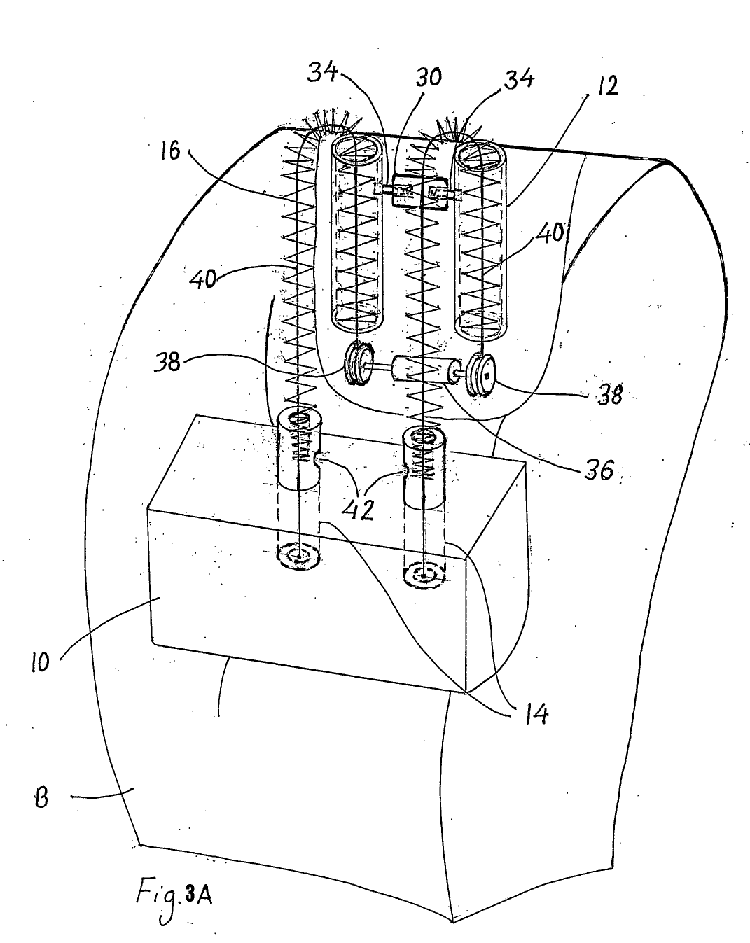

FIGS. 2A-2C show another embodiment of the headrest assembly of the present invention wherein the mechanism for positioning support cushion 10 in a location that does not block a driver's view outside the vehicle includes a pair of upper bars 20 that are pivotally attached to a pair of lower bars 22, which extend into pipes 12 in the back support B. Bars 20 and 22 are joined by a pivot arrangement, exemplified by corresponding narrow extensions 24 and 26 that are pivotably joined by an axis or pivot 28. Typically, one of the bars 20 or 22 has a slot 29 (for example bar 20, as illustrated) whereby bar 20 can be raised with respect to bar 22 for ease of pivoting. In addition, or alternatively, the ends of extensions 24 and 26 could be rounded (not illustrated) to facilitate the pivot movement. The back support B comprises a cut out C with a depth deep enough to accommodate the pivot arrangement whereby cushion 10 is positionable below the top of the seat.

To remove the headrest from blocking the sight of the driver, cushion 10 is pulled upward until the pivot mechanism is removed from within pipes 12 and the cushion is laid down along back support B. When the pivot mechanism is so removed from pipes 12, bars 20 and 22 will pivot relative to each other whereby bars 20 will tilt downward, along with the cushion 10, toward back support B and out of the driver's view. In this embodiment, the headrest is manually returned to the operable (upright) position.

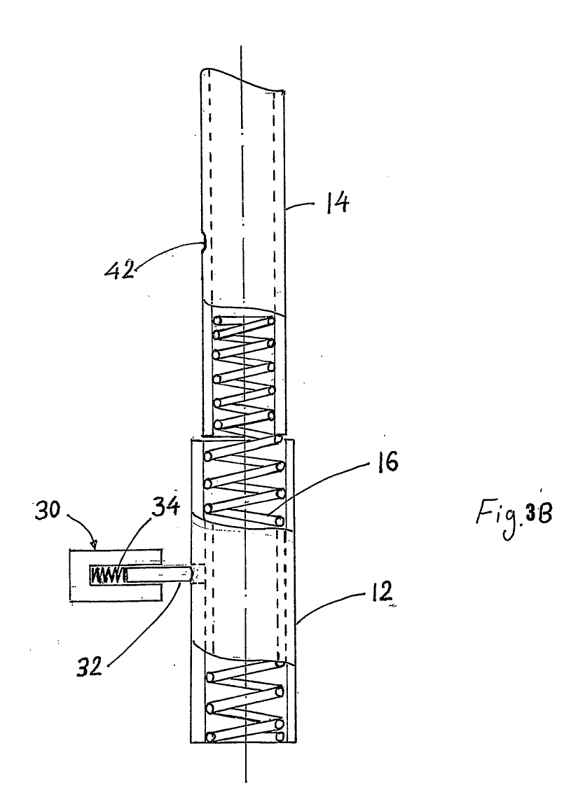

FIGS. 3A and 3B depict another embodiment of the present headrest assembly comprising an automatically operable mechanism for placing the headrest in an operable position and a position wherein it does not block the driver's view outside the vehicle. The design is similar to that of the embodiment illustrated in FIGS. 1A-1C, however, further comprising a solenoid 30 with a solenoid pin 32 (or pair thereof, as shown in FIG. 3A) biased by a solenoid spring(s) 34 (FIG. 3B) for automatically activating the non-blocking position of the headrest; and comprising a headrest (cushion) retracting motor 36; a pair of spools 38, operably connected to the motor 36; and a pair of cables 40, each cable passing through the springs 16, the cables 40 being connected at one end to the spools 38 and at an opposite end to the cushion 10 or interior of pipes 14.

When the headrest is in its operable upright position, solenoid pin(s) 32 is disposed within a notch(es) 42 of pipe(s) 14. The pipe(s) 14 typically have a series of notches 42 to allow adjustment of the headrest cushion 10 to a desired height. The spring(s) 34 biases the pin(s) 32 to enter into notch(es) 42. Upon powering the solenoid 30 the pin(s) 32 is retracted from the notch(es) 42 and springs 16, which were in a compressed position push pipes 14 upward and out from pipes 12 whereby the cushion 10 is positioned against the back support B. The solenoid 30 can be powered by an actuator button (not shown) located for example at the vehicle's dashboard (not shown).

According to some embodiments, the cushion 10 and pipes 14 can be manually replaced into their upright operable position. According to other embodiments, motor 36 can be activated so as to spin the spools 38 and reel in cables 40 thereby replacing the headrest to the upright and operable position.

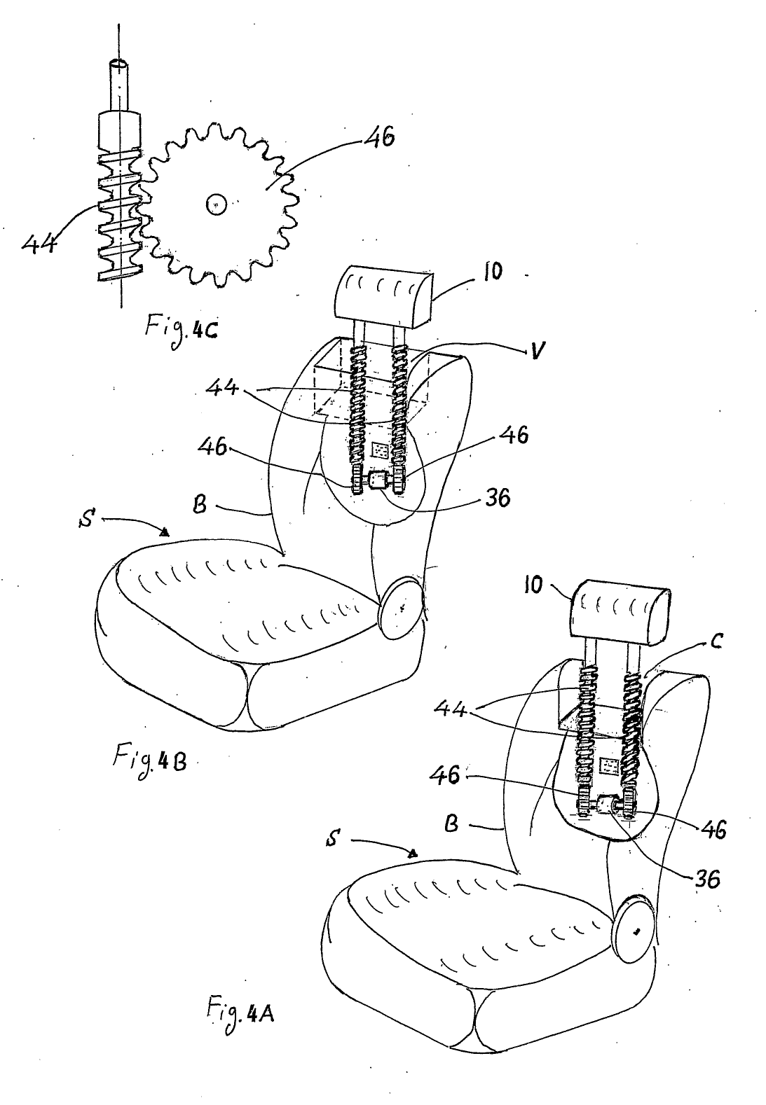

FIGS. 4A-4C show other embodiments of the headrest assembly of the present invention for use in combination with a back support B of a vehicle seat S, the back support having a cutout C (FIG. 4A) or a cavity V (FIG. 4B) therein large enough to receive cushion 10. The headrest apparatus comprises a pair of spirally threaded rods 44; a pair of corresponding gear wheels 46; and a cushion/rod raising and lowering motor, such as motor 36, operably connected to the pair of gear wheels 46. The motor 36 can be actuated by any suitable manner, for example a button or switch conveniently located to the driver. Upon activation the motor 36 causes the gear wheels 46 to spin whereby the headrest cushion 10 can be either retracted into the cutout C or cavity V; or extended upward to a desired position.

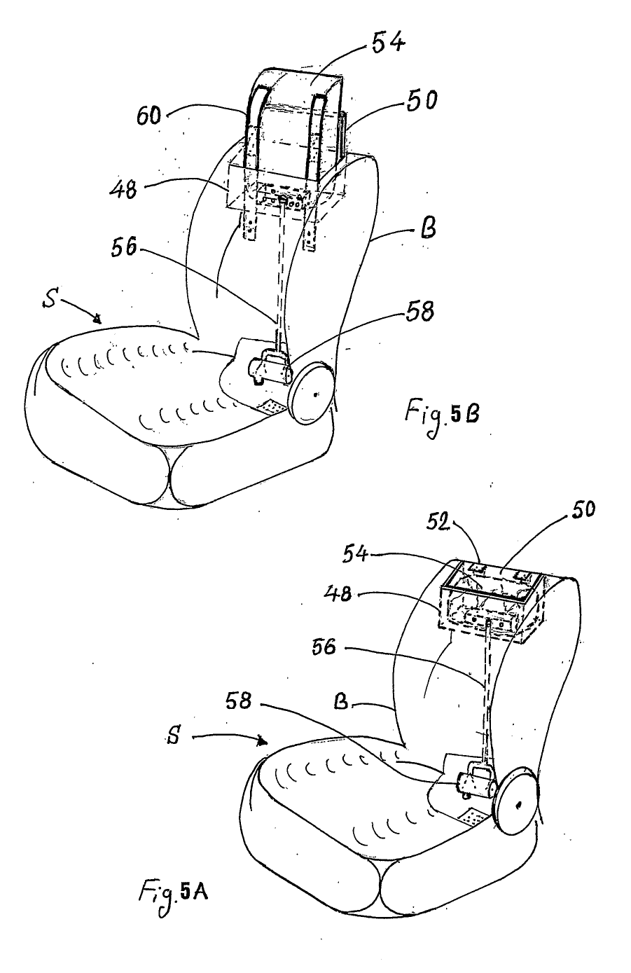

FIGS. 5A and 5B show additional embodiments of the headrest of the present invention for use in combination with a back support B of a vehicle seat S. The back support includes therein a headrest cushion compartment 48 having a top 50 pivotably attached thereto by one or more hinges 52. Prior to deployment of the headrest (FIG. 5A), within the compartment 48 is disposed an inflatable member 54, which acts as a headrest cushion when deployed. The inflatable member 54 is typically made of a gas impermeable plastic, which can be covered by a relatively soft material for passenger comfort. The inflatable member 54 is operably connected, for example by a tube 56, to a pump 58 designed for inflating and deflating the inflatable member 54. The pump 58 is operably connected to an electrical power source (not shown) which can be activated by a button or switch (not shown), typically conveniently located near the driver.

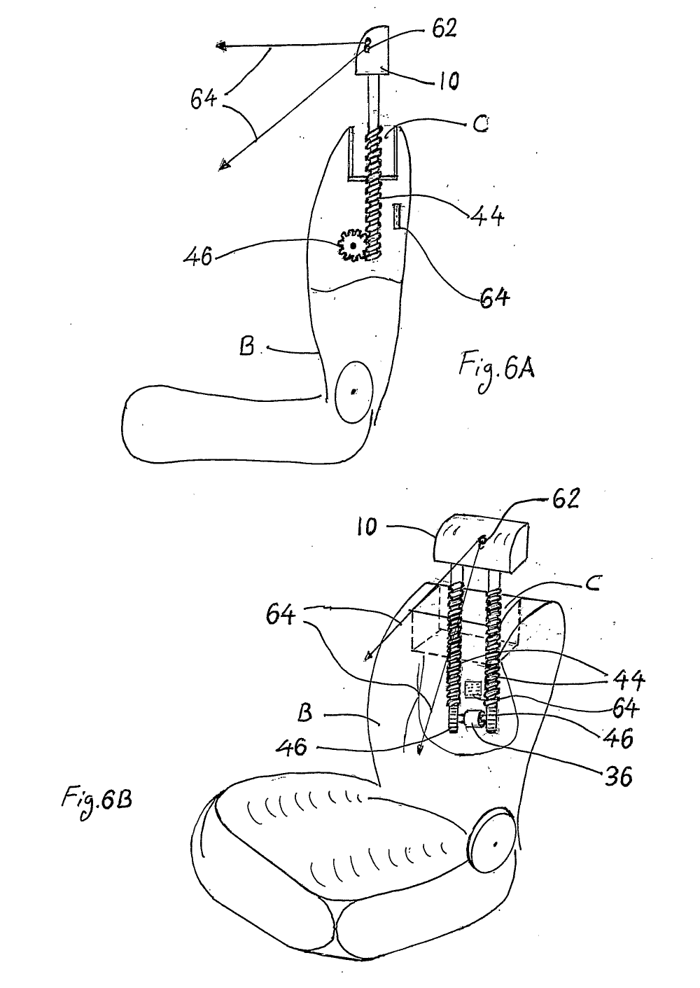

In order to further support and position the inflatable member 54 when it is inflated, in some embodiments the headrest includes one, or more typically a pair of inflatable member support and positioning straps 60 (FIG. 6B) attached to the inflatable member 54 and anchored at the compartment 48 or a portion of the back support B.

When the headrest is actuated to inflate, pump 58 pumps air into inflatable member 54 whereby it expands and pushes the top 50 of compartment 48 up and back. The top 50 can be hinged to the compartment 48 whereby it provides support to the inflatable member attached; and further, straps 60, if present, can provide support as well. The proper extent of inflation can be controlled by any appropriate method, for example, by a pressure regulator (not shown) or a predetermined amount of pumping time.

When the driver wishes to retract the cushion (i.e. inflatable member 54), the pump 58 can be actuated in a vacuum or suction mode to deflate inflatable member 54, which then retracts back into the cushion compartment 48. Hinges 52 may comprise biasing members (not shown) to help close the top 50 of the compartment 48.

FIGS. 6A and 6B show a modification to the embodiment illustrated in FIGS. 4A and 4B; however, it should be understood that such a modification can be used in combination with other embodiments of the present headrest and the present invention. Here, the headrest assembly comprises a sensor 62, typically disposed in the cushion 10 and facing forward toward where a passenger is sitting, or may sit. The sensor 62 is designed to determine if a passenger is sitting in the seat S and thereby retract or extend the headrest automatically; and for such purpose sensor 62 is operably connected to motor 36 by motordriver 64. In accordance with some embodiments, there is another type of sensor, for example a weight sensor (not shown) that is used to determine if a passenger is sitting in the seat S.

The fine adjustment of the height of the cushion 10 can be performed by the driver or via the passenger, for example by an override mechanism, not shown; else, the sensor 62 may comprise an adjustment feed back to the motor 36 to place the cushion 10 in the proper location for example by aiming beams 64 at various angles to determine the top of the passenger's head.

1. A headrest assembly in combination with a vehicle seat, the headrest assembly comprising:
a headrest cushion;
a mechanism for placing the headrest cushion from an operable position to a position such that the cushion does not block the outside view of a driver,
said mechanism comprising:
(at least one first pipe connected to the vehicle seat;
at least one second pipe connected to the cushion and fitable within the at least one first pipe; and
a stretchable and flexible member disposed within each of the at least one first pipe and at least one second pipe, each stretchable and flexible member being attached to the second pipe(s) or the cushion, whereby the cushion can be raised and laid on part of the vehicle seat below the top of the vehicle seat;
wherein the stretchable and flexible member is a dual diameter spring.

2. (canceled)

3. (canceled)

4. The headrest assembly according to claim 1, wherein the dual diameter spring has a portion with a first diameter approaching the inner diameter of the first pair of pipes; and a portion with a second diameter approaching the inner diameter of the at least one second pipe.

5. The headrest assembly according to claim 1, wherein the spring is compressed when the at least one second pipe is positioned within the at least one first pipe and the assembly further comprises a solenoid adapted so that the solenoid can release the at least one second pipe from within the at least one first pipe whereby the spring pushes the at least one second pipe out of the at least one first pipe and the cushion hangs down adjacent to the seat below the top of the seat.

6. The headrest assembly according to claim 5, further comprising a cushion retracting mechanism for retracting the cushion back into an operable position.

7. The headrest assembly according to claim 6, wherein the cushion retracting mechanism comprises a cable generally disposed along or within the stretchable and flexible member and operably attached to the cushion and operably attached to a cushion retracting motor for retracting the cushion back into an operable position.

8. (canceled)

9. (canceled)

10. (canceled)

11. The headrest assembly according to claim 1, further comprising a sensor for facilitating automatic height adjustment of the cushion and/or for determining if a passenger is seated in the seat.
